(19) United States
(12) Patent Application Publication
(10) Pub. No.: US 2008/0216621 A1
(43) Pub. Date: Sep. 11, 2008

(54) Underfloor Wheel Set Lathe for Machining Wheel Sets of Railway Vehicles

(75) Inventors: Theo Nijssen, Beesel (NL); Hans-Joachim Reiche, Erkrath (DE)

Correspondence Address: HARNESS, DICKEY & PIERCE, P.L.C., P.O. BOX 828, BLOOMFIELD HILLS, MI, 48303, US

(73) Assignee: HEGENSCHEIDT-MFD GMBH & CO. KG, Erkelenz (DE)

(21) Appl. No.: 11/794,740

(22) PCT Filed: Jan. 7, 2006
(86) PCT No.: PCT/EP06/00078

§ 371 Date: Mar. 10, 2008

(30) Foreign Application Priority Data
Jan. 10, 2005 (DE) 10 2005 001 220.5

(51) Int. Cl. B23B 5/32

(52) U.S. Cl. 82/105

(57) ABSTRACT

The present invention relates to an underfloor wheelset lathe for machining the profile of wheels (8, 9) of wheelsets for railway vehicles, in which the wheelsets are rotatably mounted in axle bearing housing outside the wheels (8, 9), with a machine bed (10), two supports mounted on the machine bed that can be moved in the X and Z-axis direction of the underfloor wheelset lathe and are provided for holding tools for the machining, entry track rails (5, 6) that can be removed during machining for positioning the wheels (8, 9) over the tools, clamping elements for gripping the axle bearing housings, roller pairs for each wheel (8, 9) for lifting, driving and lowering the wheelset before, during and after machining. The underfloor wheelset lathe is intended for installation in an inspection shaft (1) for rail vehicles. It has a machine bed (10) with a vertical height (11) that is less than the depth (2) of the inspection shaft (1). A lateral recess (15, 16) is located in the inspection shaft (1) in the area of each of the ends of the machine bed (10) for the purpose of accommodating the clamping elements, drives for the roller pairs and the removed entry track rails (5, 6).

### CROSS-REFERENCE TO RELATED APPLICATION

This application is a National Stage of International Application No. PCT/EP2006/000078, filed Jan. 7, 2006, which claims priority to German Application No. DE 001 220 5-14, filed Jan. 10, 2005. The disclosures of the above applications are incorporated herein by reference.

### FIELD

The present invention relates to an underfloor wheelset lathe for machining wheelsets for railway vehicles in accordance with the precharacterising clause of the main claim.

### BACKGROUND

Underfloor wheelset lathes are preferably used for reprofiling the wheels of wheelsets, in which case the wheelsets remain installed in the railway vehicle and the railway vehicle is rolled over the underfloor wheelset lathe. Consequently, the underfloor wheelset lathes are let into the workshop track where the reprofiling should be performed. As a rule, they have a vertical height between 2 and 2.5 metres and consequently require a deep pit underneath the workshop track. In addition, it is necessary to have a solid foundation for absorbing the machining forces and in order to avoid vibration during machining.

The deep pit and large foundations entail a corresponding level of complexity and expense, and demand special measures for the installation of an underfloor wheelset lathe. As a result, there has been no lack of thought devoted to reducing the requirements of an underfloor wheelset lathe. For example, European patent application 0 557 231 A2 discloses an underfloor wheelset lathe for railway wheels with a weight reduced by between 80 and 85% in comparison to conventional underfloor wheelset lathes (see column 2, lines 13 to 20). However, the reduced weight of the disclosed underfloor wheelset lathe does not necessarily mean that the disclosed underfloor wheelset lathe also entails a reduction in the complexity of the process for installing an underfloor wheelset lathe.

As a result, it is the task of the present invention to propose an underfloor wheelset lathe that can be arranged in the inspection shaft without requiring major additional works, the inspection shaft in question being of the type that normally exists in workshops for inspection purposes and for undertaking minor jobs on railway vehicles.

### SUMMARY

In accordance with the present invention, this task is accomplished by an underfloor wheelset lathe that is suitable for installation in an inspection shaft and has a machine bed with a vertical height that is lower than the depth of the inspection shaft, with a lateral recess located in the inspection shaft in the area of each of the ends of the machine bed for the purpose of accommodating the clamping elements for the wheelset, the drives for the roller pairs and the removed entry track rails.

A roller pair is provided for each wheel of the wheelset with two individual rollers located at a lateral distance from one another that is slightly larger than the depth of a support of the machine and the associated tools in the direction of the entry track rails. The rollers of the roller pair are used for lifting, driving and putting down the wheelset again before, during and after machining. Once the wheelset has rolled into the machine, it is supported by the rollers which simultaneously lift it in the vertical direction. This means it comes clear of the entry track rail and can be pulled out to the side. The section of the entry track rail that is provided for pulling out, however, is only wide enough as required for the depth of the support and the machining tools located on it. As a result, the lateral distance between the individual rollers of the roller pair is also not significantly larger than the depth of a support and the corresponding tools in the direction of the entry track rails.

Each of the entry track rails of a workshop track has a removable section with a length that is slightly longer than the depth of a support and the corresponding tools in the direction of the entry track rails. In this way, the discontinuity in the workshop track due to the entry track rails to the underfloor wheelset lathe is limited to the smallest possible value required for the tools to be able to perform the reprofiling of the circumference of the wheel disc.

The supports with the tools are provided in the middle between the wheel discs of the wheelset. They have lateral continuations in the direction of the entry track rails, and it is possible to keep these continuations sufficiently flat that they can engage in the gap without further complications by pulling out the section of the workshop track that is required for the entry.

The individual rollers of each roller pair are rotatably mounted in rockers with swivel axes running parallel to the lengthways axis of the wheelset and at a radial distance from it that is larger than the radius of a wheel of the wheelset.

The vertical height of the bed of the underfloor wheelset lathe is between 600 mm and 1000 mm, and in a preferred embodiment is 800 mm. The inspection shaft of a workshop track, by comparison, generally has a depth of about 1600 mm measured from the top surface of the rail. The reduced height of the bed of the underfloor wheelset lathe even makes it possible for the chips arising from the machining process to be caught and stored under the bed of the underfloor wheelset lathe. The situation is similar with the vertical height of the lateral recesses that have to be provided in the inspection shaft in order to accommodate the clamping elements for the axle bearing boxes as well as the drives for the rollers. Further control devices such as an electrical cabinet and a hydraulic unit can easily be arranged on the workshop floor adjacent to the underfloor wheelset lathe, because they are generally only connected to the underfloor wheelset lathe by means of cables and lines.

Also, the width of the lateral recesses in the inspection shaft does not require any particular measures to be taken because it is in a range from 600 mm to 1000 mm, with the width in a preferred embodiment being 800 mm, measured from the adjacent entry track rail. The situation is the same with the depth of the lateral recesses measured in the direction of the workshop track.

The following section describes the invention with a design example.

### DRAWINGS

The following figures are highly simplified, schematic and not to scale.

FIG. 1 shows a section through an underfloor wheelset lathe through the longitudinal centre.

FIG. 2 shows a support with longitudinal slide and cross slide.

FIG. 3 shows a side view of the support shown in FIG. 2.

FIG. 4 shows the bearings of the rockers for the rollers of a roller pair.

FIG. 5 shows a plan view of the rocker configuration.

FIG. 6 shows the assembly, crossbeam and carrier for the roller rockers.

FIG. 7 shows a probe that can be swiveled in.

FIG. 8 shows how a wheelset is lifted by the rollers.

FIG. 9 shows a removable section of the entry track rail.

FIG. 10 shows a side view of the roller support and the drive of a wheel set.

FIG. 11 shows a plan view of the roller support and the drive of a wheel set.

### DETAILED DESCRIPTION

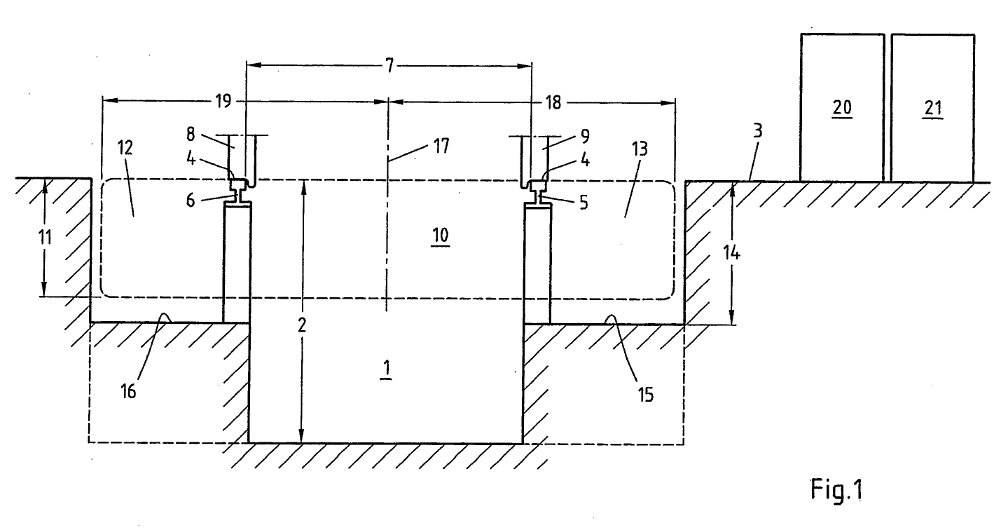

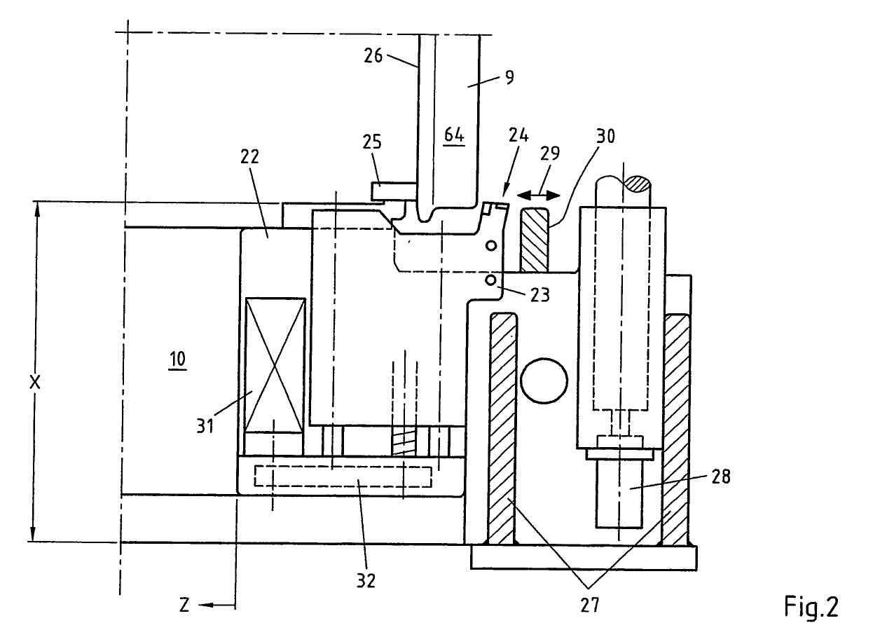

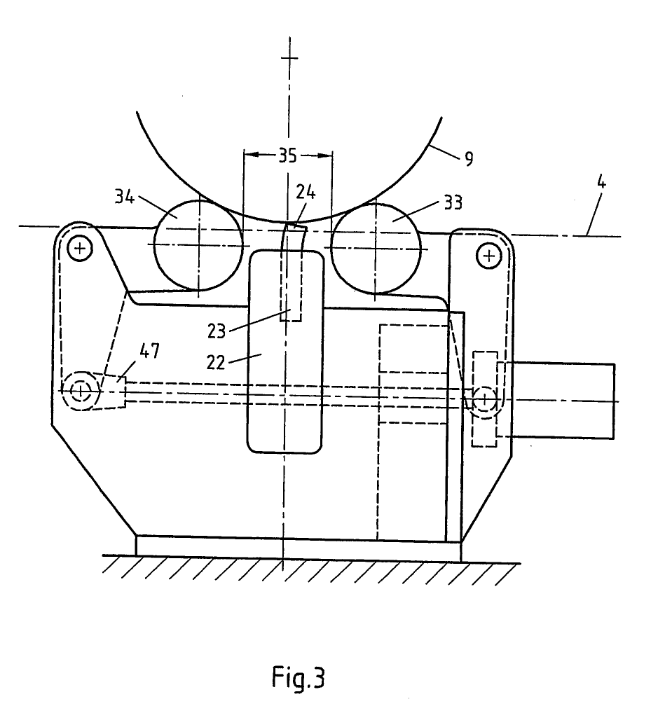

An inspection shaft 1 has a vertical depth 2 below the workshop floor 3 that amounts to between 1000 mm and 1600 mm. The top edge 4 of the entry track rails 5 and 6 forming the workshop track 7 is located at the height of the workshop floor 3. Both the wheels 8 and 9 of a wheelset (not shown) are rolled along the workshop track 7 over an underfloor wheelset lathe, of which only the outline of the bed 10 is indicated in FIG. 1 by way of dashed lines. The vertical height 11 of the bed 10 is between 600 mm and 1000 mm, and in a preferred embodiment is 800 mm. The bed 10 protrudes in all directions laterally beyond the entry track rails 5 and 6. The protruding parts of the bed 10 are indicated with the numbers 12 and 13. The vertical depth 2 of the lateral recesses 15 and 16 of the inspection shaft 1 is slightly greater than the vertical height 11 of the bed 10 and its protruding parts 12 and 13. The longitudinal centre of the inspection shaft 1 is identified with the number 17 and the two numbers 18 and 19 indicate the lateral limit of the two protruding parts 12 and 13 beyond the inspection shaft 1. As well as the underfloor wheelset lathe, there is also an electrical cabinet 20 and a hydraulic unit 21 located on the workshop floor 2 outside the inspection shaft 1, being provided for controlling the machine. Two supports 22 that can be moved in the X and Z-axis directions are arranged on the bed 10, with only the right-hand support being shown in FIG. 2. The support 22 has a lateral arm 23 pointing in the direction of the protruding part 13 and carrying machining tools 24 that are provided for reprofiling the wheel disc 9. A lateral guide roller 25 rotatably mounted on the bed 10 or the support 22 supports the wheel disc 9 from the inside of the wheel 26. On the side of the bed 10 there is a frame 27 in which an element 28 is mounted that is provided for clamping the wheelset at the axle bearing housings (65).

A removable section 30 of the entry track rail 5 slides on the top side of the frame 27 and can be moved in both directions 29. In addition, a drive 31 with a reduction gear 32 is provided for driving the support 22 in the movement directions X and Z. The drive 31 of the support 22 in the movement direction Z is positioned on the outside of the bed 10.

After the removable section 30 has been pulled out of the entry track rail 5 sideways, the wheel 9 of the wheelset is supported on rollers 33 and 34 of a roller pair. There is a lateral distance 35 between rollers 33 and 34, the depth of which in the direction of the entry track rail 5 is sufficient to allow the arm 23 of the support 22 to pass through with the machining tools 24. The rollers 33 and 34 belong to a roller pair by means of which the wheel 9 can be lifted off the entry track rail 5, started turning and then lowered back onto the entry track rail 5.

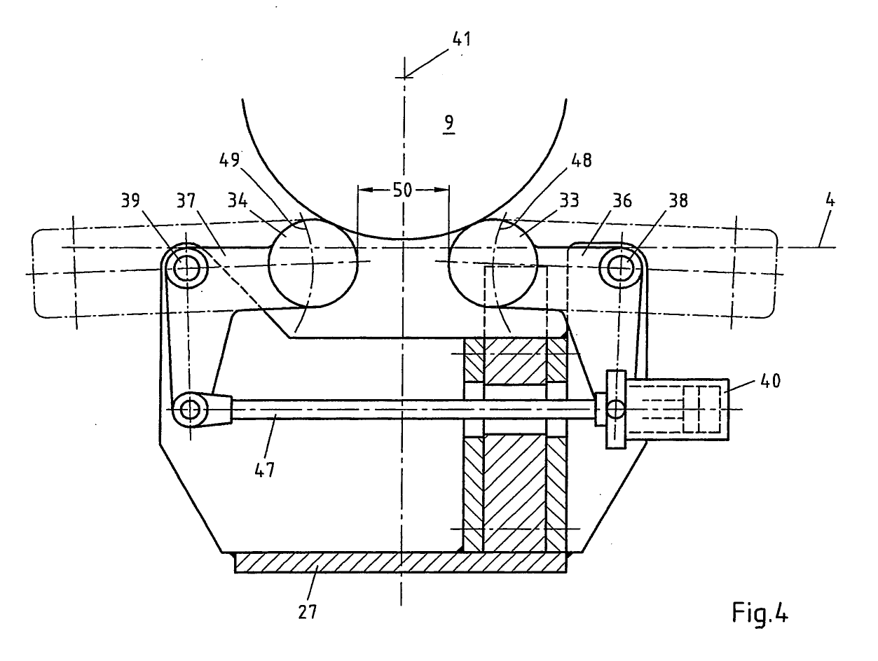

As shown in FIG. 4, the two rollers 33 and 34 are each mounted in rockers 36 and 37 that can in turn be swiveled about the swivel axes 38 and 39 with the help of a drive 40. The swivel axes 38 and 39 extend in the Z-axis direction of the machine and are parallel to the axis of rotation 41 of the wheelset. They are located at a distance from the axis of rotation 41 that is larger than the radius of one of the wheels 8 or 9. The rockers 36 and 37 are also mounted in the frame 27.

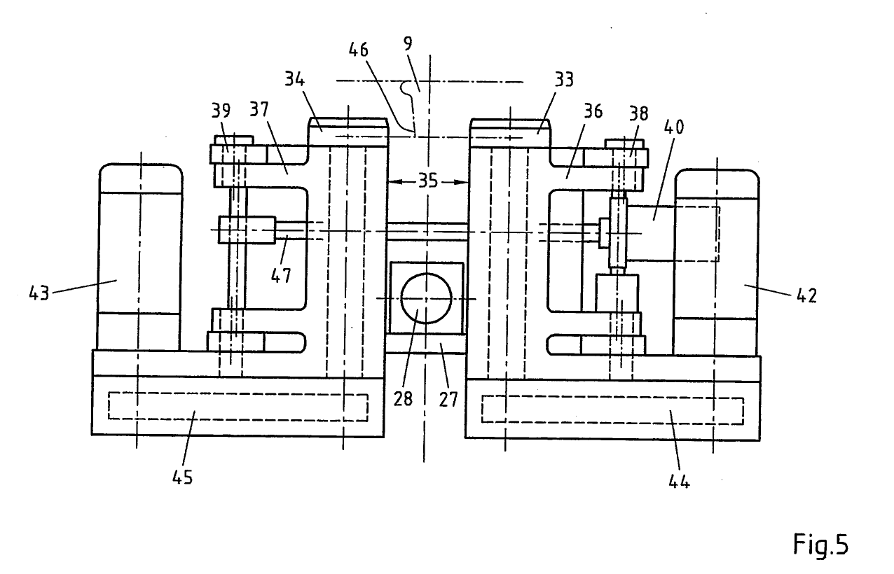

The plan view in FIG. 5 first shows the two rollers 33 and 34 with their mutual distance 35. One wheel 9 of the wheelset is brought into the working position between the two rollers 33 and 34. Each of the two rollers 33 and 34 is rotatably mounted in one of the rockers 36 or 27. The motors 42 and 43 are provided with corresponding reduction gears 44 and 45 in order to drive the rollers 33 and 34. The clamping element 28 is arranged between the rockers 36 and 37. FIG. 5 shows particularly clearly that the wheel 9 is supported by both rollers 33 and 34 in the area of its outer edge 46. The rocker drive 40 with its extension rod 47 is intended to move the two rollers 33 and 34 by means of the corresponding rockers 36 and 37 along the circular arcs 48 and 49. As part of this kinematic system, the rollers 33 and 34 can be lowered by the drive 40 and its push rod 47 as far as below the top edge of the rail 4. In this position, the wheelset is able to roll into the underfloor wheelset lathe. Actuating the drive 40 then causes both rollers 33 and 34 to move upwards along their respective circular arcs 48 and 49. As they do so, they grip the wheel 9 of the wheelset in the area of its front end 46 and lift up the entire wheelset until it reaches a position as shown in FIG. 4. In this working position, the removable section 30 is first of all pulled out of the rail 5. The wheelset is fixed by the clamping element 28. The lateral arm 23 of the support with the machining tools 24 moves into the gap 50 between the two rollers 33 and 34. The rollers 33 and 34 are set rotating by the motors 42 and 43 and they also cause the wheel 9 of the wheelset to turn. This means the wheel 9 is reprofiled by the machining tools 24.

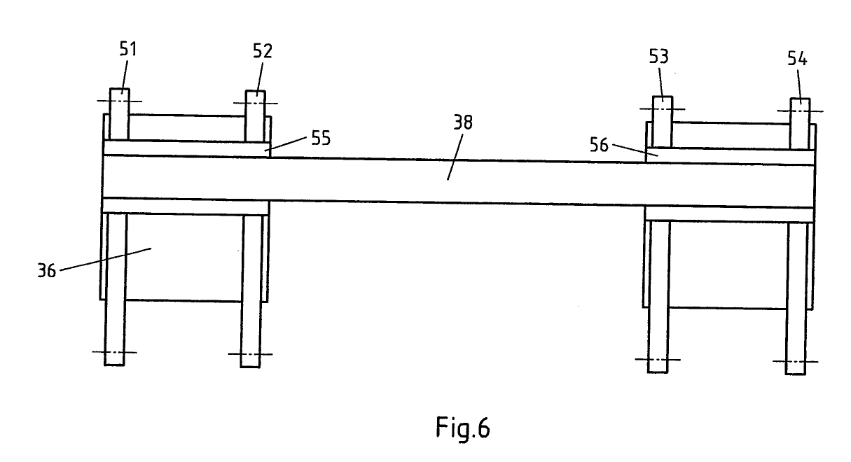

FIG. 6 shows the assembly of the crossbeam and the carriers for the roller rockers 36 and 37. Each of the rockers 36 is initially rotatably mounted in a swivel axis 38. Each rocker 36 or 37 has four individual rocker arms 51, 52, 53 and 54. Bearing bushes 55 and 56 ensure that the rockers 36 or 37 have a low-friction mounting.

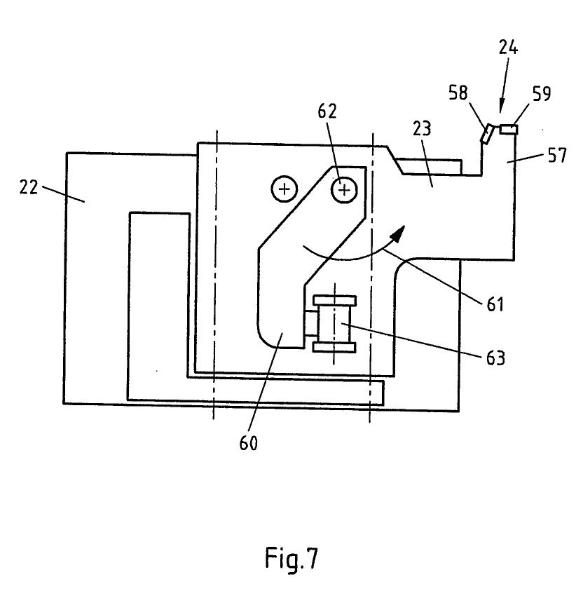

FIG. 7 shows the support 22 again with its lateral arm 23. A continuation 57 on the end of the arm 23 carries the machining tools 58 and 59. The machining tools 58 and 59 are lathe tools. Whereas the lathe tool 58 is preferably intended for cutting the running surface of the wheel 9, the lathe tool 59 is preferably intended for machining the wheel flange of the wheel 9. In addition, a probe 60 is mounted in a swiveling arrangement on the support 22. The swiveling direction is indicated by the arrow 61. When the probe 60 swivels around the swivel axis 62, a pair of measuring rollers 63 comes into contact with the running surface 64 of the wheel 9. The result of the work can be checked in this way. Following completion of the measurement, the probe 60 moves back to its parked position as shown in FIG. 7.

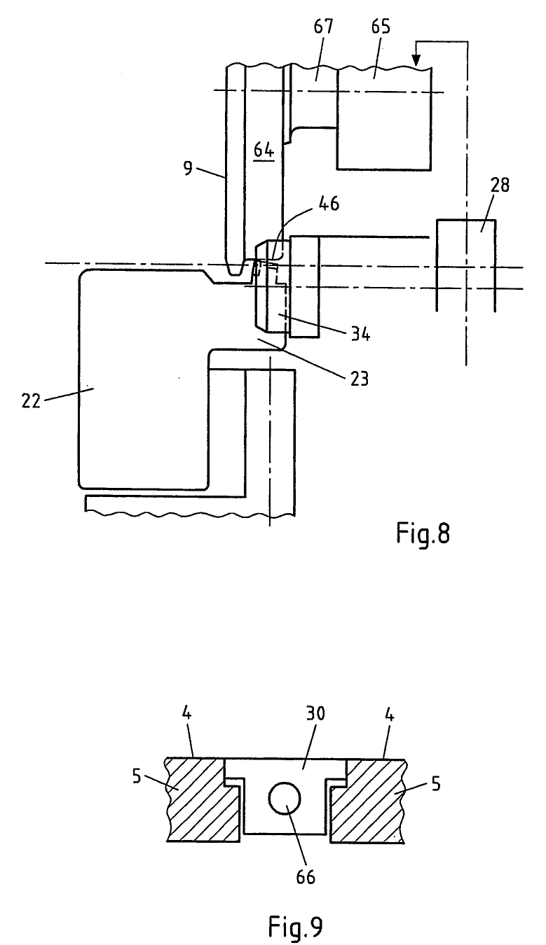

FIG. 8 shows the procedure of lifting the wheelset once again as a front view. The wheelset is mounted with its axle journals 67 in axle bearing housings 65. The wheel 9 of the wheelset is supported in the front area 46 of its running surface 64 by the roller 34. In the plane of the image behind the roller 34, the lateral arm 23 of the support 22 projects into the gap between the rollers 33 and 34. The clamping element 28 is also indicated.

FIG. 9 shows the removable section 30 as it is provided in the rail 5. The removable section 30 has the shape of a T-piece and includes a hole 66. A pushing element (not shown) engages into the hole 66 that allows the removable section 30 to be pulled sideways out of the rail 5 and pushed back in.

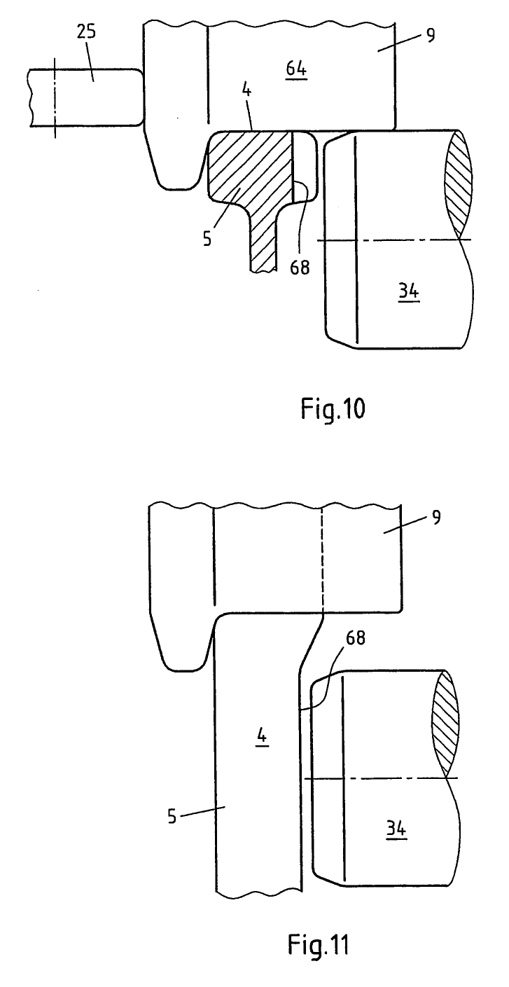

FIG. 10 shows a lateral section through the roller support of the wheel 9. The wheel 9 rolls along the rail 5 into its machining position on the underfloor wheelset lathe. The wheelset is axially guided by the back up roller 25 in the direction of its axis of rotation 41. The wheel 9 is supported in the front area 46 of its running surface 64 by the roller 34. The rail 5 has a lateral recess 68 so that the roller can be moved as far as possible up to the rail 5. The description of the roller 34 in FIGS. 10 and 11 applies equally for the roller 33. This also applies to the rollers (not shown) for the machining situation of the wheel 8 that are opposite to the rollers 33 and 34.

1-9. (canceled)

10. An underfloor wheelset lathe for machining wheel profiles of wheelsets for railway vehicles where the wheelsets are rotatably mounted in axle bearing housing outside the wheels, the underfloor wheelset lathe intended for installation in an inspection shaft for rail vehicles, comprising:
an inspection shaft for a rail vehicle;
a machine bed with a vertical height that is less than the vertical depth of the inspection shaft;
two supports mounted on the machine bed that can be moved in an X and Z-axis direction of the underfloor wheelset lathe, said supports holding tools for machining the wheelsets;
entry track rails, that can be removed during machining, for positioning the wheels over the tools;
clamping elements for gripping the axle bearing housings;
roller pairs for each wheel for lifting, driving and lowering the wheelset before, during and after machining; and
a lateral recess located in the inspection shaft in the area of each of the ends of the machine bed for the purpose of accommodating the clamping elements of the drives for the roller pairs and the removed entry track rails.

11. The underfloor lathe according to claim 10, wherein individual rollers of the roller pair are located at a lateral distance from one another that is slightly larger than the depth of a support and the associated tools in the direction of the entry track rails.

12. The underfloor lathe according to claim 10, wherein the entry track rail with a removable section has a length that is slightly longer than the depth of a support and the corresponding tools in the direction of the entry track rails.

13. The underfloor lathe according to claim 12, wherein the removable section of the entry track rail can be pulled out towards the lateral recess of the inspection shaft sideways adjacent to the corresponding entry track rail.

14. The underfloor lathe according to claim 11, wherein the individual rollers of the roller pair are rotatably mounted in rockers with swivel axes running parallel to the lengthways axis of the wheelset and at a radial distance from it that is larger than the radius of a wheel.

15. The underfloor lathe according to claim 10, wherein the vertical height of the bed is between 600 mm and 1000 mm.

16. The underfloor lathe according to claim 15, wherein the vertical height is 800 mm.

17. The underfloor lathe according to claim 10, wherein the vertical height of the lateral recess in the inspection shaft is between 600 mm and 1000 mm.

18. The underfloor lathe according to claim 17, wherein the vertical height is 800 mm.

19. The underfloor lathe according to claim 17, wherein the width of the lateral recess in the inspection shaft is between 600 mm and 1000 mm, measured from the adjacent entry track rail.

20. The underfloor lathe according to claim 10, wherein the width is 800 mm.

21. The underfloor lathe according to claim 12 wherein the supports located close to a longitudinal center of the inspection shaft and lateral arms that point towards the adjacent entry track trail are suitable for holding the tools and for engaging in a gap that is formed in the entry rail after the removable section has been pulled out.
